(19) United States
(12) Patent Application Publication
(10) Pub. No.: US 2004/0113867 A1
(43) Pub. Date: Jun. 17, 2004

(54) Head-mountable display system

(75) Inventors: Hideki Tomine, Campbell, CA (US); Rodney J. Bumgardner, Los Gatos, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Kopin Corporation, Taunton, MA

(21) Appl. No.: 10/643,210

(22) Filed: Aug. 18, 2003

Related U.S. Application Data
(63) Continuation of application No. 10/313,899, filed on Dec. 5, 2002.
(60) Provisional application No. 60/336,665, filed on Dec. 5, 2001.
(60) Provisional application No. 60/343,027, filed on Dec. 20, 2001.
(60) Provisional application No. 60/347,771, filed on Jan. 11, 2002.
(60) Provisional application No. 60/366,512, filed on Mar. 20, 2002.
(60) Provisional application No. 60/387,286, filed on Jun. 7, 2002.

(51) Int. Cl. G09G 5/00

(52) U.S. Cl. 345/8

(57) ABSTRACT

Various embodiments of a head-mountable display system can be adapted to allow users to see through or above or below the display assembly. Such range of vision can be achieved by positioning the display assembly into display pods housed in clear plastic; forming the frame into an “S”-shape positioned on the bridge of the nose so as to allow the user to see over it; positioning retractable display pods into a hard support frame, or other means. Various parts of the head-mountable display system, such as temple arms, ear phones, display assembly, and the head band, can be modified so as to achieve ergonomically optimal solution.

### RELATED APPLICATIONS

This application is a continuation of U.S. application Ser. No. 10/313,899, filed Dec. 5, 2002, which claims the benefit of U.S. Provisional Application No. 60/336,665, filed Dec. 5, 2001, No. 60/343,027, filed Dec. 20, 2001, No. 60/347,771, filed Jan. 11, 2002, No. 60/366,512, filed Mar. 20, 2002, and No. 60/387,286, filed Jun. 7, 2002. The entire teachings of the above applications are incorporated herein by reference.

### BACKGROUND

Various head-mountable display systems have been developed. These display systems include monocular and binocular display optics. In binocular systems, the optics and supporting electronics can be designed to render identical images for viewing by a user or different images for stereoscopic viewing by the user. Commercial display systems typically employ liquid crystal display panels.

There are three principal types of prior art head-mountable display systems: “see-through systems, ” where the displayed electronic image is combined with ambient imagery so the user views both images; “see-around systems, ” where the displayed image occludes a part of the ambient imagery; and “full-immersion systems, ” where the entire ambient image is blocked, so that the user views only the electronically generated image.

### SUMMARY

There is a need for a head-mountable display system that addresses ergonomical concerns, making head-mounted display systems more practical for the user. In addition, it is desirable to reduce the amount of occluded view, making the display system more usable by the user and more acceptable to third parties dealing with the display user. Other ergonomical features, such as viewing angle, fit, and comfort, may also greatly improve the usability of the system.

In accordance with particular embodiments of the invention, a display system can include a frame wearable on the head of a user and an imaging system that is coupled to the frame. The imaging system can be used to present a viewable image to the user at a view angle from below the user's eye level. Such imaging system can be rotatable to adjust the view angle.

The imaging system can include a display pod, which can also be rotatable to adjust the viewing angle. The rotation can be done about an associated eye pivot to track the eye's optical axis. The rotation can also be done about an associate ear pivot, not tracking the eye's optical axis.

The display system can include a mirror-lens optical system, or it can include an optical relay.

The frame that is worn on the head of the user can be essentially transparent within the user's field of view. In addition, the frame can be so shaped as to facilitate peripheral vision of the user.

The imaging system can include a prism. The prism can be aligned vertically or horizontally relative to the user. The imaging system can also fold into the frame for storage. A headband can be attached to the frame. The headband can be used to hold electronic components and the battery.

The head-mountable display system can augment or even replace cell phones. In addition, it can be used for mobile gaming—either in conjunction with the cell phone, or as a stand-alone system.

The display system can also communicate with other devices using interfaces like Bluetooth, infrared (e.g., IRDA), or cable-based protocols. The games can be specifically designed for a particular display system, or the ones available for other devices.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a head-mountable display system of one embodiment of the invention.

FIG. 2 is a side view of the display system of FIG. 1 being worn by a user.

FIG. 3 is a perspective view of a head-mountable display system of a second embodiment of the invention.

FIG. 4 is a side view of the display system of FIG. 3 worn by a user.

FIG. 5 is a perspective view of a head-mountable display system of a third embodiment of the invention.

FIG. 6 is a side view of the display system of FIG. 5 worn by a user.

FIG. 7 is a side view of a head-mountable display system of a fourth embodiment of the invention.

FIG. 8 is a top view of the display system of FIG. 7.

FIG. 9 is a series of views of possible modifications of the display system of FIG. 7.

FIG. 10 is a top view of a head-mountable display system of a fifth embodiment of the invention.

FIG. 11 is a front view of the display system of FIG. 10.

FIG. 12 is a side view of a head-mountable display system of a sixth embodiment of the invention.

FIG. 13 is a perspective view of a head-mountable display system of a seventh embodiment of the invention.

FIG. 14 is a side view of the display system of FIG. 13 worn by a user.

FIGS. 15A-15C are respective views of a first prism-based embodiment of the invention being worn by a user.

FIGS. 16A-16C are representative views of a second prism-based embodiment of the invention being worn by a user.

FIGS. 17A-17C are respective views of a bar-type embodiment of the invention being worn by a user.

FIGS. 18A-18C are respective view of a second bar-type embodiment of the invention being worn by a user.

FIGS. 19A-19C are respective views of a folded optics-type embodiment of the invention being worn by a user.

FIGS. 20A-20C are respective views of a horizontal prism-type embodiment of the invention being worn by a user.

FIG. 21 is a perspective view of a head-mountable display system having a curved clear lens element.

FIG. 22 is a perspective view of a head-mountable display system of one embodiment of the invention being worn by a user.

FIG. 23 is a perspective view of a head-mountable display system of another embodiment of the invention being worn by a user.

FIGS. 24A-24C are representative views of a head-mountable display system of yet another embodiment of the invention.

FIG. 25 is a perspective view of a display system of yet another embodiment similar to that of FIGS. 24A-24C.

FIG. 26 is a perspective view of a head-mountable display system of yet another embodiment of the invention being worn by a user wearing glasses.

FIG. 27 is a schematic representation of mirror-lens technology of one embodiment of the invention.

FIG. 28 is a schematic diagram of the optical system of FIG. 27.

FIG. 29A as a perspective view of a head-mountable display system having a pivotable display rod.

FIG. 29B is a plan view of a display pod and display pod support of FIG. 29a.

FIG. 30 is a perspective view of a head-mountable display system of another embodiment of the invention having a pivotable display pod.

FIG. 31 is a perspective view of a head-mountable display system of yet another embodiment of the invention.

FIGS. 32A-32B are schematic diagrams showing rotational requirements for a display pod of one embodiment of the invention.

FIGS. 33A-33C are schematic diagrams of the display system of FIG. 31.

FIGS. 34A-34C are schematic diagrams of a particular implementation of the display systems of FIGS. 29A-29B and 30.

FIGS. 35A-35C illustrate another implementation of the display system of FIG. 31.

FIGS. 36A-36C illustrate yet another implementation of the display system of FIGS. 29A-29B and 30.

FIGS. 37A-37E are schematic diagrams of the display system of yet another embodiment of the invention.

FIGS. 38A-38B illustrate a panoramascope image in accordance with one embodiment of the invention.

FIG. 39 is the imaging of FIGS. 38A-38B.

FIG. 40 is an example of two sets of characteristics of mirror dimensions of one embodiment of the invention.

FIG. 41 is a perspective drawing of a head-mountable display device of yet another embodiment of the invention.

FIG. 42 is a series of drawings of a head-mountable display device of yet another embodiment of the invention.

FIG. 43 is a perspective drawing of a head-mountable display device of an embodiment similar to the embodiment of FIG. 42.

FIGS. 44A and 44B are perspective drawings of a head-mountable display device of yet another embodiment of the invention.

### DETAILED DESCRIPTION

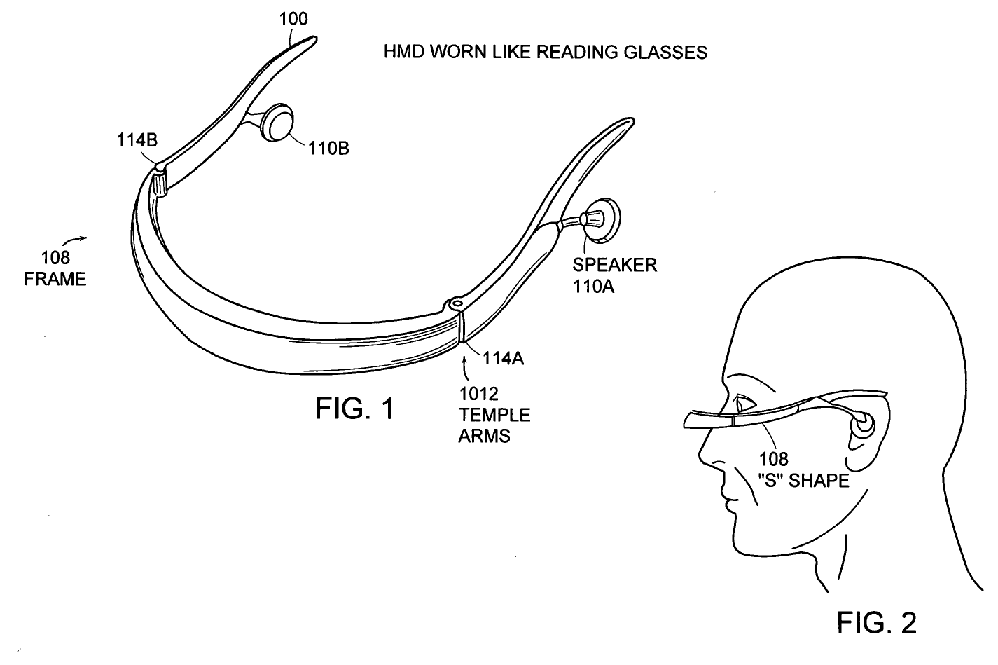

FIG. 1 is a perspective view of a head-mountable display system of one embodiment of the invention. A head-mountable display system 100 consists of a frame 108 that houses a display system that can provide a user with binocular views. The frame 108 also consists of temple arms 112a, 112b that are hinged on hinges 114a and 114b, respectively. The temple arms 112 fold for storage. Also shown are stereo headphone speakers 110a, 110b. The headphone speakers 110 can be attached to the temple arms 112. In another embodiment of the invention, headphone speakers can be of different shapes than shown, as determined by one skilled in the art. The headphone speakers 110 fit into user's ears as shown in FIG. 2.

FIG. 2 is a side view of the display system 100 of FIG. 1 being worn by a user. As shown, the system 100 is worn like reading glasses. The frame 108 has an “S”-shape to limit blockage of the user's peripheral vision.

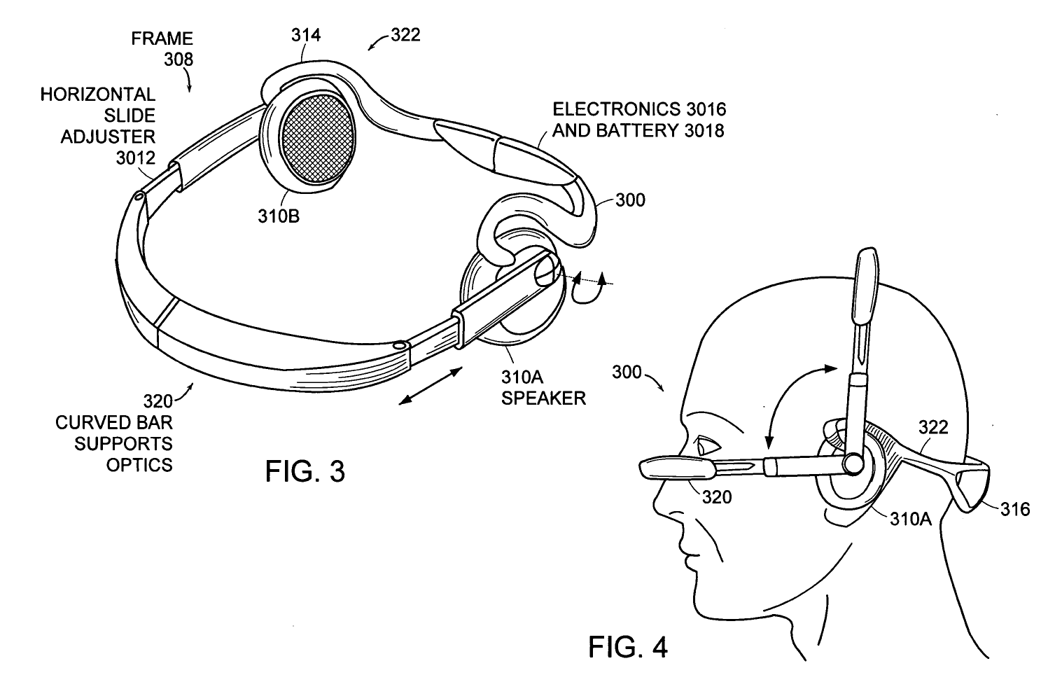

FIG. 3 is a perspective view of a head-mountable display system of a second embodiment of the invention. In system the 300, display objects are enclosed in a curved bar 320. The curved bar 320 can be adjusted by a horizontal slide adjustor 312, thus making it more comfortable for the user. Attached to the frame 308 of the head-mounted display system 300 is a headband 322, which houses electronic components 316 and battery 318. The headband can serve as a counterbalance to the optics.

FIG. 4 is a side view of the display system of FIG. 3 worn by a user. As shown, the optics bar 320 can also pivot. The shape of the frame 308 can be adjusted in alternative embodiments of the invention to comply with different ergonomic requirements. As shown, the frame 308 has been designed to be worn comfortably by the user. Speakers 310a, 310b fit over the user's ears, as shown in FIG. 4. In another embodiment of the invention, the speakers 310a, 310b can be designed to fit in the user's ears, or be attached to the frame differently. The optics bar 320 can be stored at different positions and stowed away at angles 90° and above from the original horizontal position over the user's eyes.

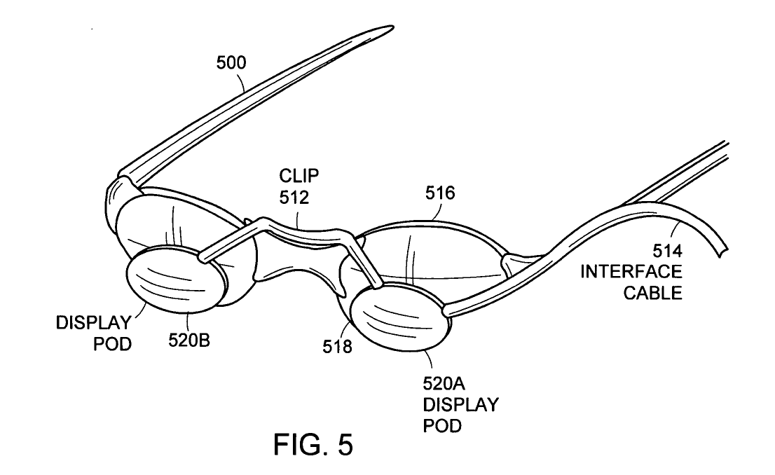

FIG. 5 is a perspective view of a head-mountable display system of a third embodiment of the invention. The head-mountable display system 500 includes binocular display pods 520a, 520b, that can be clipped onto eyewear by a clip 512. The eyewear can be eyeglasses, such as those normally worn by the user, or as specifically designed for the head-mountable display system. An interface cable 514 to the display pods 520a, 520b can be removably coupled to the eyewear, as shown in FIG. 5.

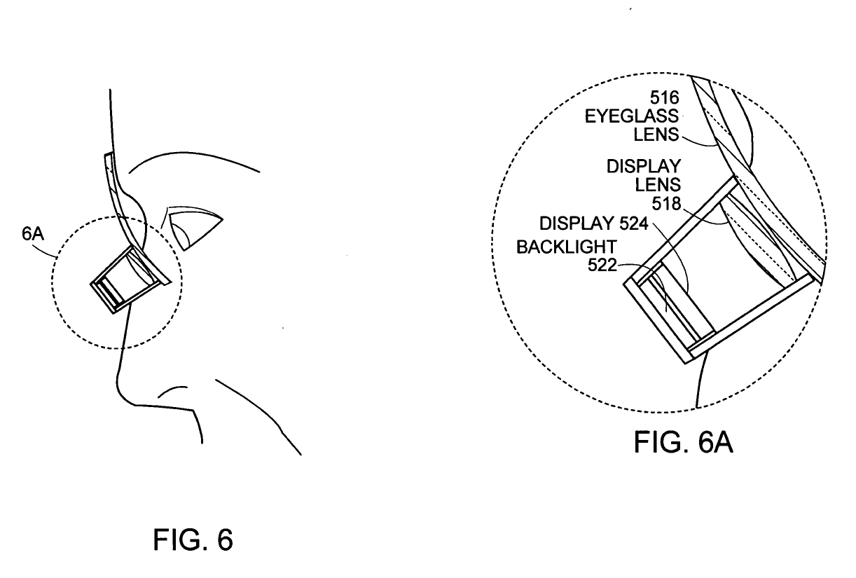

FIG. 6 is side view of the display system of FIG. 5 worn by a user. Shown is a side section view illustrating an eyeglass lens 516, a display lens 518, a back light 522, and a display 524. The display lens 518 and the display 524 can be mounted so as to provide for optimal viewing angle for the user's eyes.

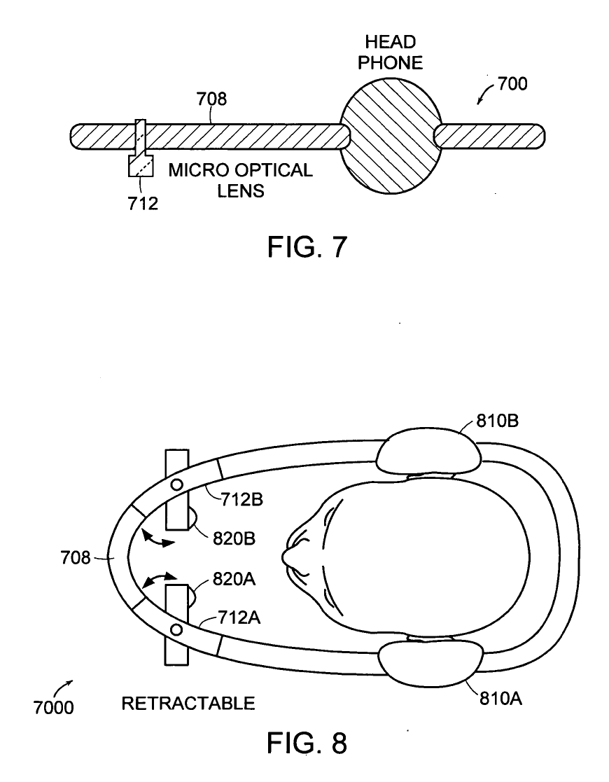

FIG. 7 is a side view of a head-mountable display system of a fourth embodiment of the invention. The display system 700 includes a frame 708. A plate or similar rigid structure can be used as the frame 708 to support display assembly 712.

FIG. 8 is a top view of the display system of FIG. 7. The display assemblies 712a, 712b can be pivotably coupled to the plate so that display lenses 820 (only one shown) can be retracted out of the user's field of view. The frame 708 can be arranged so as to extend from the user's face, thus allowing the user to see above and below it. The lenses 820a, 820b can be micro-optical lenses.

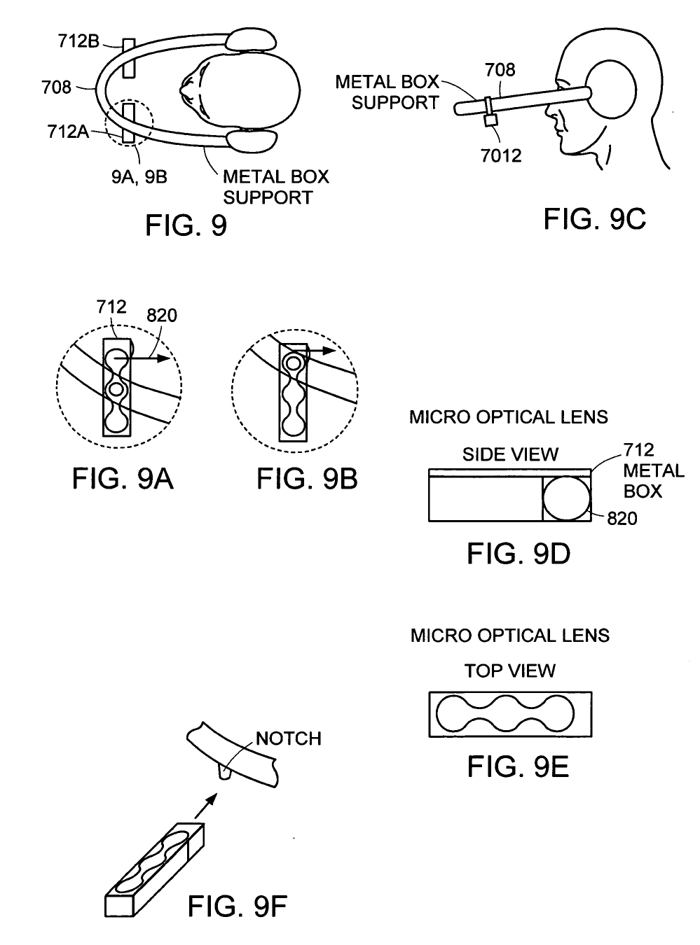

FIG. 9 is series of views of possible modifications of the display system of FIG. 7. As shown, the top of the display assembly 7012 includes detents that couple to a notch on the support bar 708. By choosing a detent, the user can adjust the viewing separation to match the user's Intrapupillary Distance (IPD). Display lenses 820 can be chosen to fit the frame 708 ergonomically or to accommodate for the user's preferences. They can be arranged in multiple positions, as determined by one skilled in the art.

IPD adjustment can be added to the system 900. The adjustable IPD can have several available positions or be infinitely adjustable. Focus can also be added in another embodiment of the invention.

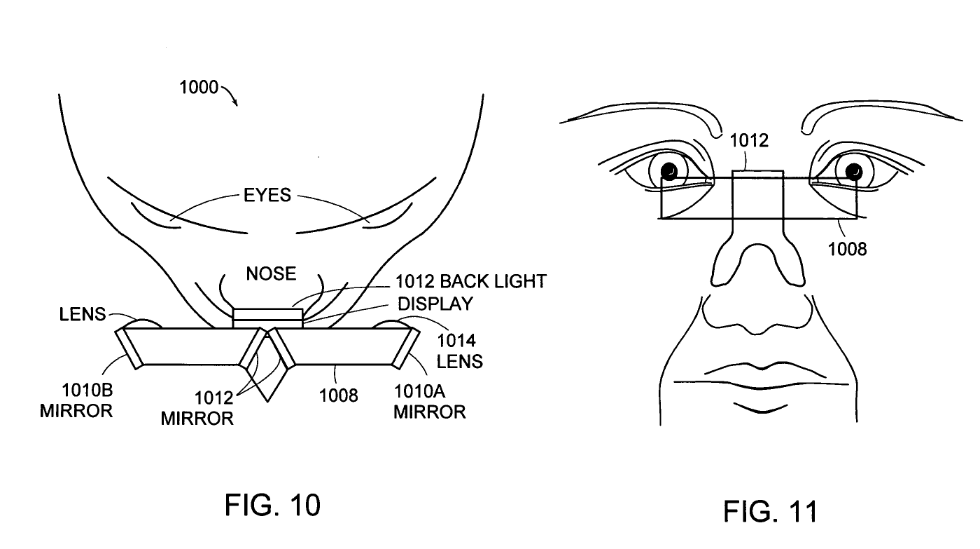

FIG. 10 is a top view of a head-mountable display system of a fifth embodiment of the invention. The display system 1000 uses a single backlit display 1008 to create a binocular display. The single image is split into two separate images by a central mirror assembly 1012. Each of the two images is then directed to a respective eye. The brain then merges the two images into a single perceived image.

FIG. 11 is a front view of the display system of FIG. 10. The total height of the back light and display is about 3-4 mm. Side mirrors 1010a, 1010b can also be used in the display system. In another embodiment, the side mirrors and the central mirror assembly 1012 can be modified to create stereoscopic images.

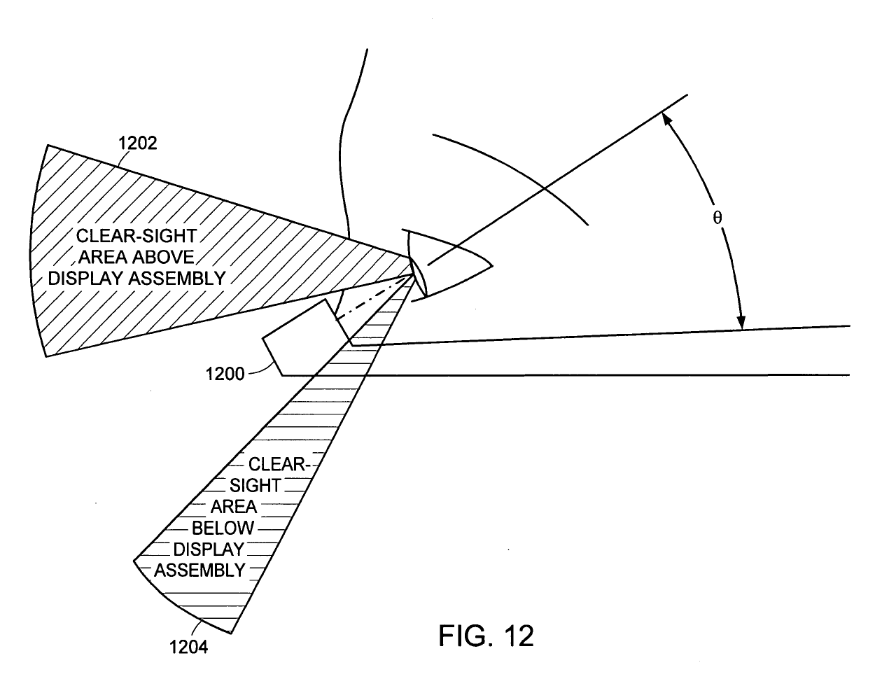

FIG. 12 is a side view of a head-mountable display system of a sixth embodiment of the invention. As shown, the display assembly 1200 is angled below the eye. This orientation provides the user with a clear sight path above and below the displayed image as illustrated by clear sight area 1202 above the display assembly 1200 and clear sight area 1204 below the display assembly 1200. Angle θ can be varied to accommodate people of different sizes, as determined by one skilled in the art. The optic axis can be aligned to the eye for easy viewing. Placing the display 1200 below the eye allows clear sight above and below the display to minimize obscuring of non-display oriented tasks.

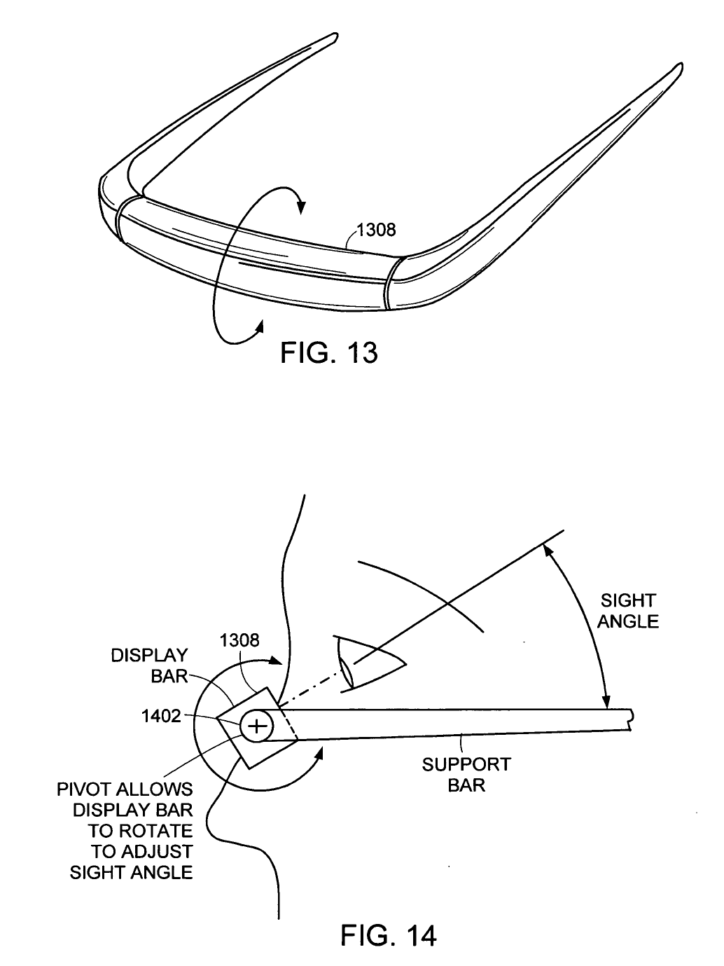

FIG. 13 is a perspective view of a head-mountable display system of a seventh embodiment of the invention. As shown, a display bar 1308 can rotate to adjust the user's sight angle while keeping the optical axis in line with the eye. FIG. 14 is a side view of the display system of FIG. 13 worn by user. The display assembly 1402 and/or display bar 1308 can be opaque, transmission, or translucent, as appropriate for particular implementation of this embodiment, as determined by one skilled in the art.

The above embodiments can be realized using a compact image display system, such as described in U.S. Pat. No. 6,204,974 to Spitzer and available from The MicroOptical Corporation of Westwood, Mass. More particularly, such embodiments can incorporate free-form prisms as optical relays between the display panel and the viewing lens. Such free-form prisms are available from Olympus Optical Co., Ltd. of Tokyo, Japan and described in U.S. Pat. No. 6,327,094 to Aoki, U.S. Pat. No. 6,323,892 to Mihara, U.S. Pat. No. 6,313,950 to Hayakawa et al., U.S. Pat. No. 6,310,736 to Togino, and U.S. Pat. No. 6,282,008 to Togino, for example. Holographic Optical Elements can also be employed in embodiments. The teachings of the above patents are all incorporated herein by reference in their entirety.

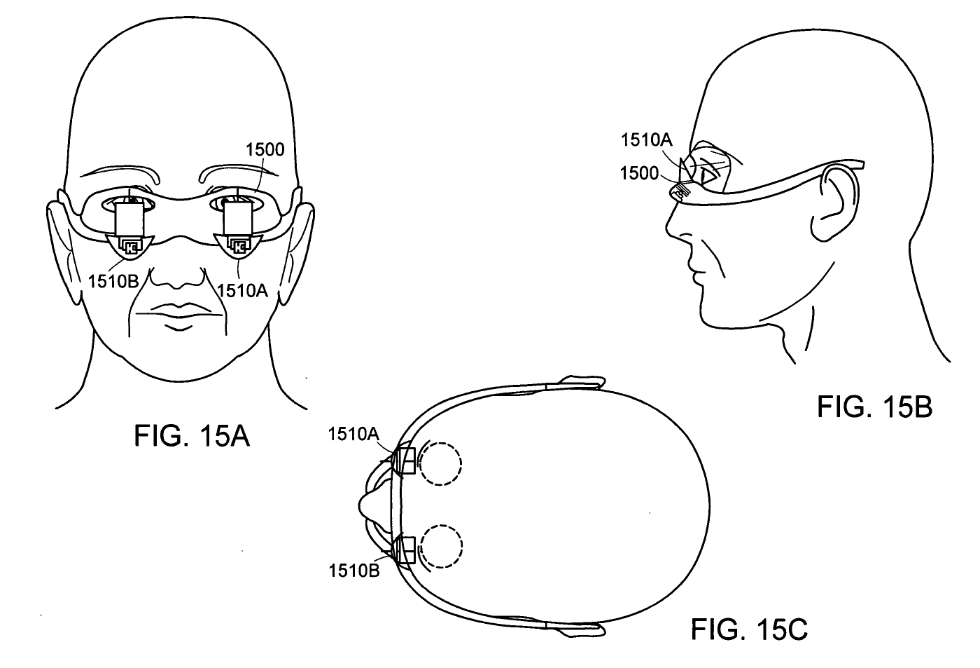

FIGS. 15A-15C are respective views of a first prism-based embodiment of the invention being worn by a user. As shown, the display system 1500 employs horizontally-oriented free-shaped prisms such as Olympus lens types 1510a and 1510b. The display system 1500 is particularly suited for QVGA resolutions.

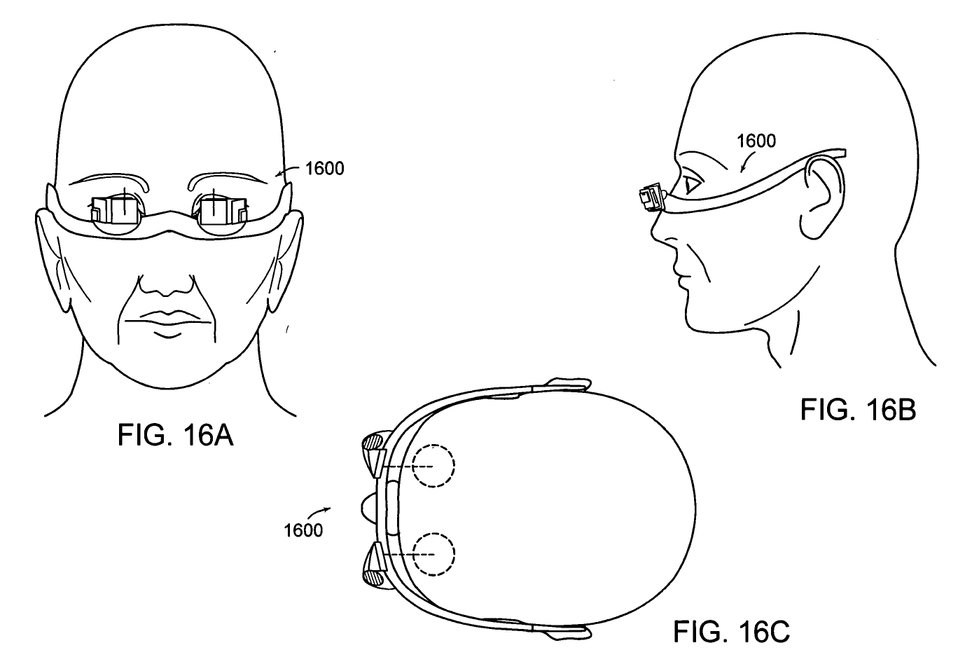

FIGS. 16A-16C are representative views of a second prism-based embodiment of the invention being worn by a user. As shown, the display system 1600 employs horizontally-oriented free-shaped prisms such as Olympus lens types. The display system 1600 is also well suited for QVGA resolutions.

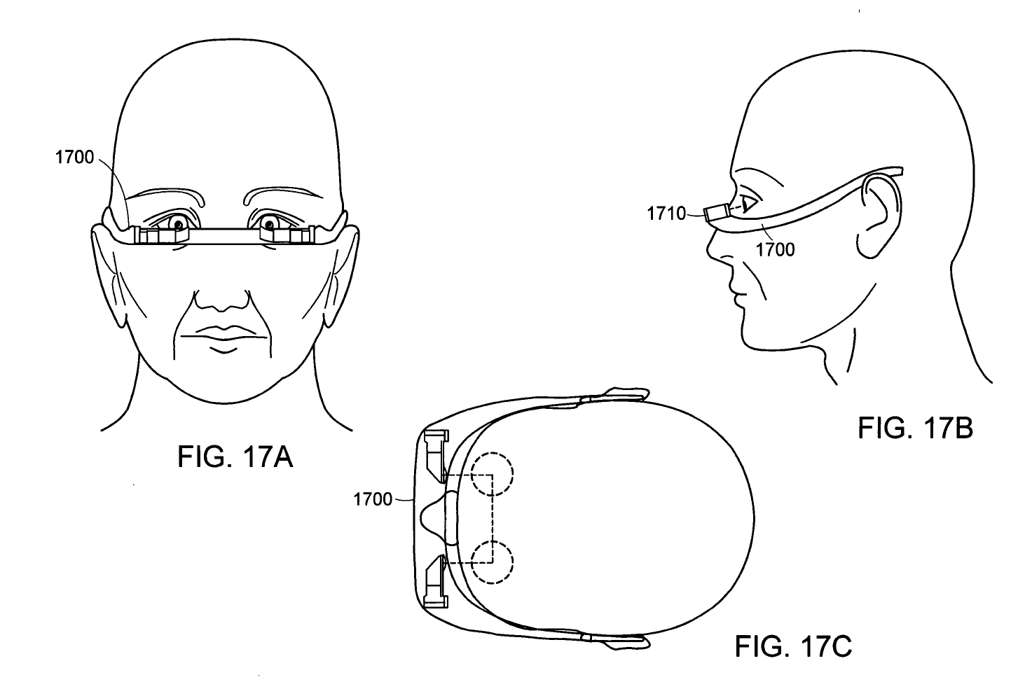

FIGS. 17A-17C are respective views of a bar-type head-mountable display system being 1700 worn by a user. As shown, the display system employs horizontally-oriented bar-type optics 1710, such as MicroOptical lens types. The display system 1700 is also well suited for QVGA resolutions.

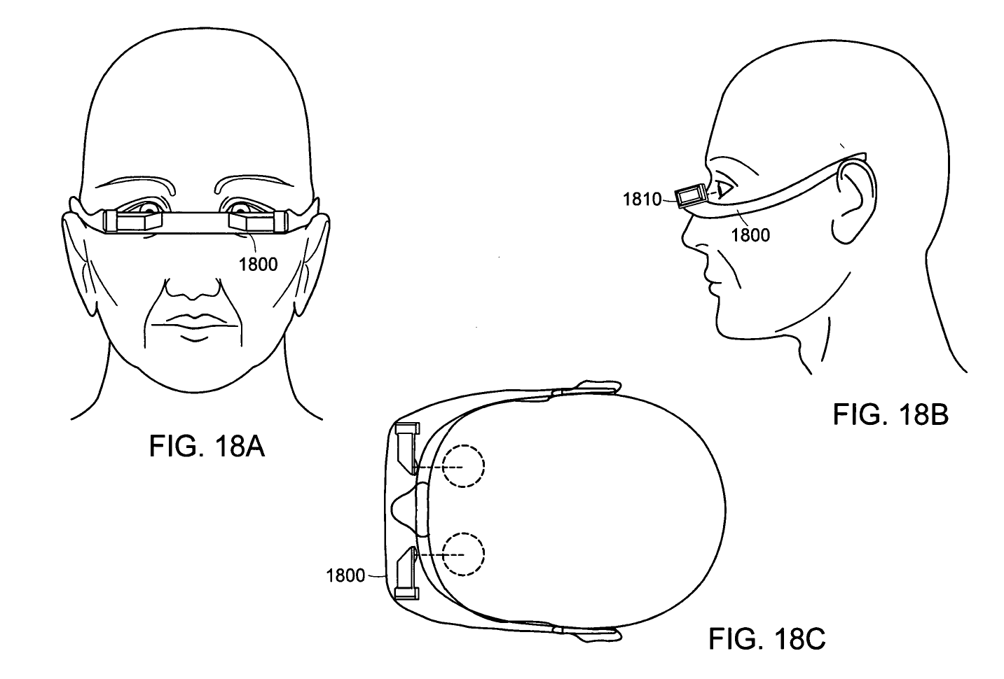

FIGS. 18A-18C are respective views of another bar-type head-mountable display system 1800 being worn by a user. As shown, the display system employs horizontally-oriented bar-type optics 1810, such as MicroOptical lens types. The display system 1800 is well suited for VGA resolutions.

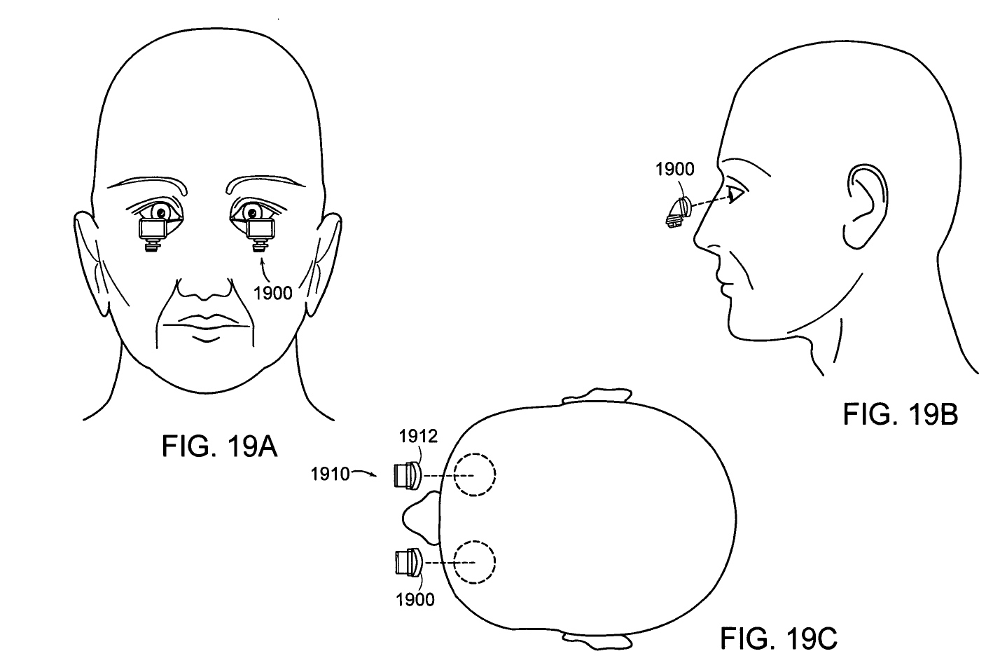

FIGS. 19A-19C are respective views of a folded optics-type head-mountable display system 1900 being worn by a user. As shown, the display system 1900 employs a folded optical element 1910, such as a mirror or prism, in combination with a one-element aspherical lens 1912. Aspheric lens system 1900 typically can have a 20 degree field of view. It can also be eyeglass compatible, with eye relief of 25 mm. or more. The display assembly can be sealed from dust. Additional scratch protection can be provided with a coverglass or an eyecup. The coverglass or the eyecup can also be used to reduce glare on the display. The display system 1900 is also particularly suited for QVGA resolutions.

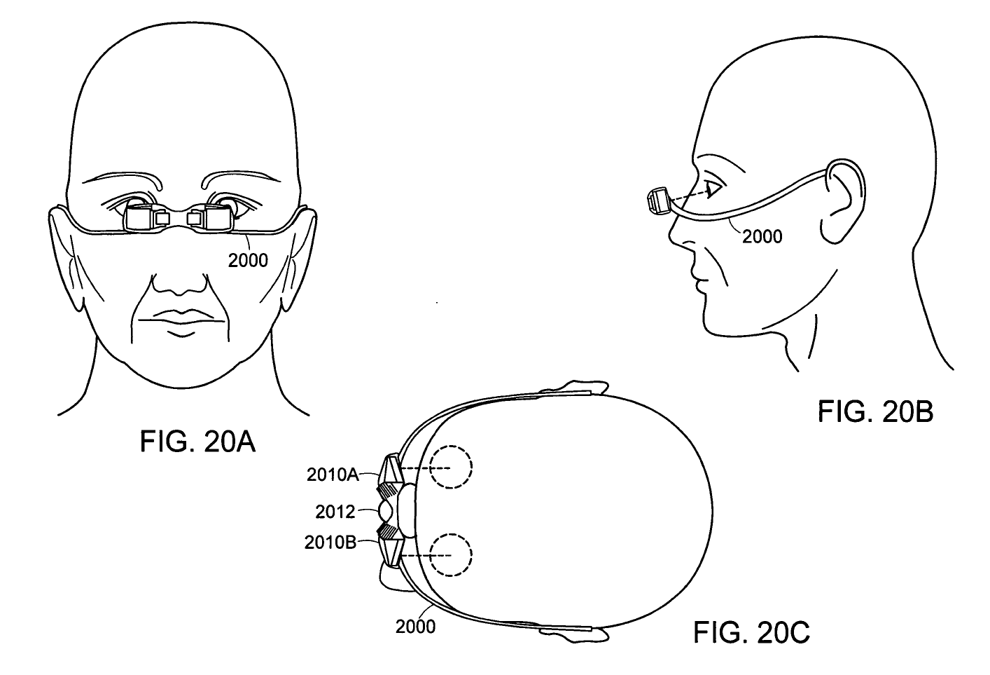

FIGS. 20A-20C are respective views of another horizontal prism-type head-mountable display system 2000 being worn by a user. As shown, the display system 1900 employs horizontal prism elements 2010a and 2020b with display panels oriented inside. The display system 2000 can be configured to be worn like reading glasses, using a thin-wire frame 2012 to support the optical components on the user's head. The display system 2000 is well suited for QVGA resolutions.

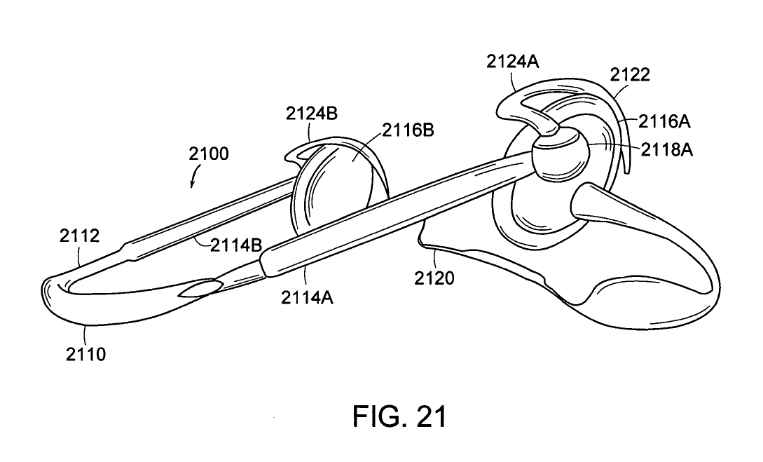

FIG. 21 is a perspective view of a head-mountable display system 2100 having a curved clear lens element 2110. The display system 2100 can employ a holographic lens, a projection lens, standard optics, a free-shaped prism, a light pipe, a mirrored or half-mirrored lens, or any other suitable lens type, as determined by one skilled in the art. A bar 2112 can be opaque and hold the lens elements. The bar 2112 can have a cut-out area for nose clearance. The curved lens element 2110 can also have a pivot on both sides to allow adjustment of the optic axis with respect to the user's eye.

The temple arms 2114a, 2114b can extend to adjust for different head sizes and can extend up when in a 90 degree up position (i.e., over the user's head). In addition, the temple arms 2114a, 2114b can pivot at speakers 2116a, 2116b to adjust a sight angle and allow unit to fold up 90 degrees (over user's head when not in use), or 180 degree for storage. A pivot 2118 not only rotates on the x-axis (horizontal), but also about the z-axis (vertical) so that the temple arms can pivot to accommodate various head sizes. Alternatively, the temple arms can be flexible enough to flex and accommodate this movement. An additional pivot at the lens area (not shown) can be utilized to allow for the adjustment of the temple arms to further accommodate various head sizes.

The temple arms 2114a, 2114b are shown with a push button 2120, which can adjust the arm length when depressed. This adjustment can also be done without a release button.

A headband 2122 can act as a spring to provide a small force to hold the system on the user's head. The headband 2122 can also include a pad/pod on the back that can house battery(s), electronics, and a wireless link (bluetooth, IR, etc.) (not shown).

Ear loops 2124a, 2124b can hook over the top of the ears to hold the unit vertically and keep it from sliding down off of the head. They can also be integrated into the headband.

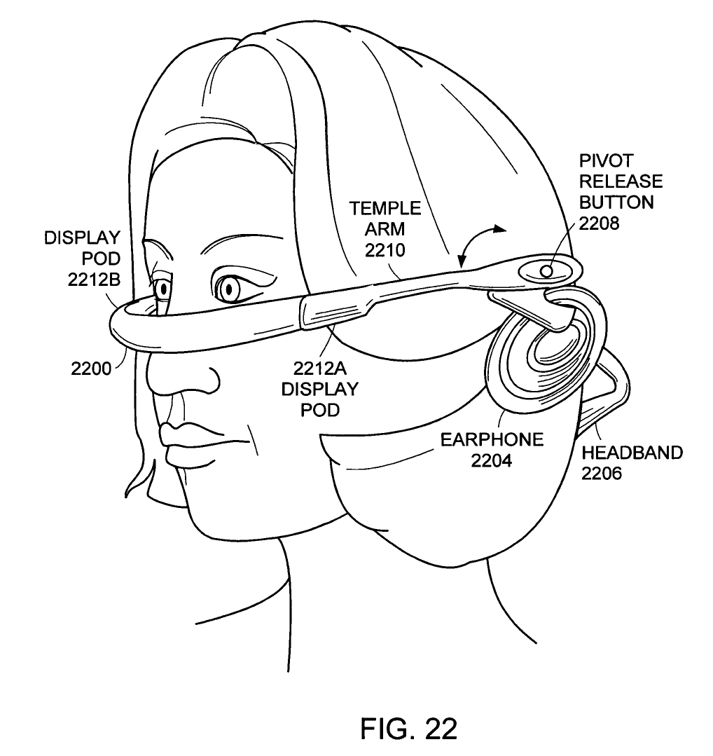

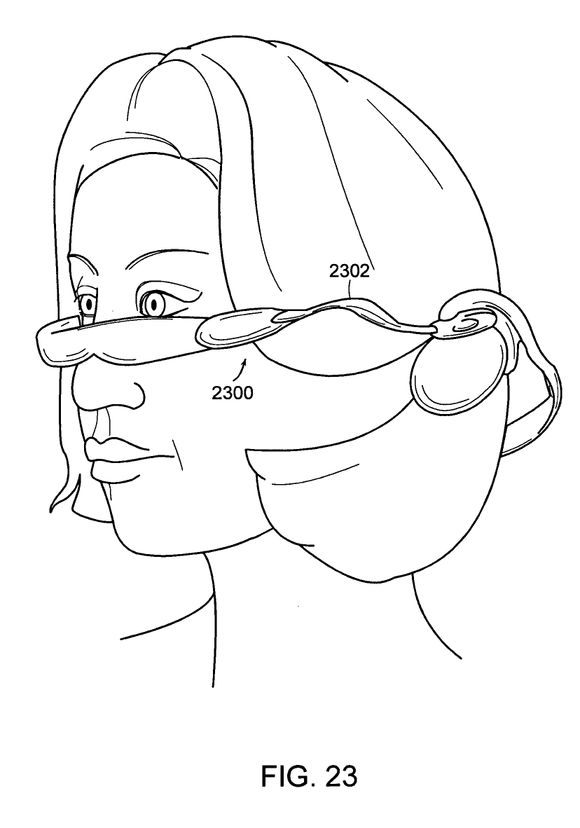

FIG. 22 is a perspective view of a head-mountable display system 2200 according to another embodiment of the invention being worn by a user. Note the nose cutout in the curved lens assembly. Liquid crystal display pods 2212a, 2212b are positioned at the ends of the temple arms. A pivot release button 2208 can be used to rotate the temple arm above the user's head.

Pod pivot can mechanically separate optics form support structure, thus isolating the optics from any mechanical loading (bending, twisting, etc.) that could affect optical alignment. Pod pivot also allows optics to be aligned to the eye viewing axis, thus presenting to the user the best display image possible and allowing the user to wear the head-mountable system in different orientations—such as, for example, wearing it down low, like reading glasses, straight ahead, or in raised position.

The low profile of the head-mountable device 2200 obscures only a small portion of the visible field, which allows the user see around the device. Not obscuring the whole field of vision allows the user to communicate with other people and safely interact with the environment.

Eyeglasses-like frame configuration is very light weight. The ears and nose are used to support the device. The similarity to glasses makes head-mountable display's use intuitive to the users. Adjustable temples allow the device to be fitted comfortably for almost anyone's head. Earpiece speaker phones can further contribute to the light weight of the device.

Temples can fold for storage, such that the whole device can be stored in a small carry case. A microphone can be build into the display pod for communication from the user.

FIG. 23 is a perspective view of a head-mountable display system 2300 being worn by a user. This display system is similar to that of FIG. 22, except for the ornamental temple arms 2302 (only one shown).

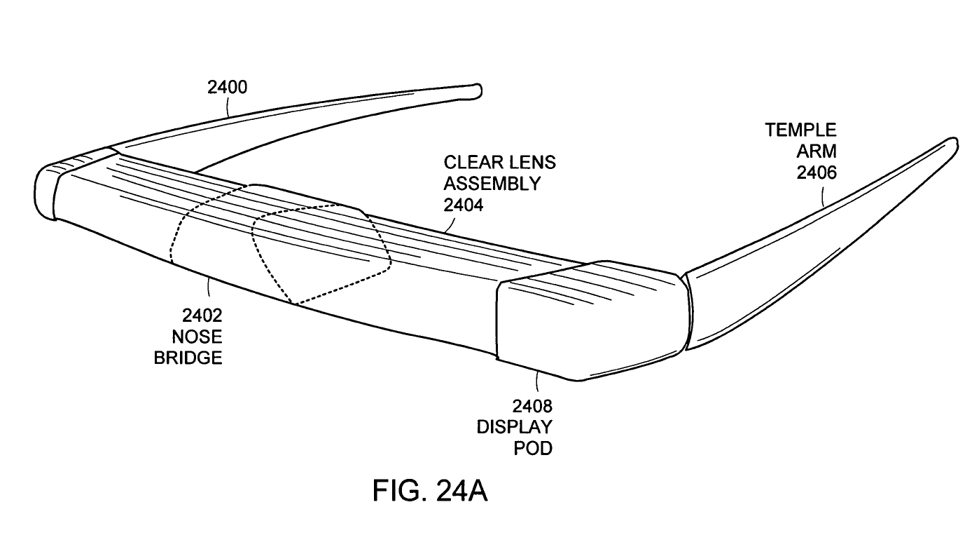

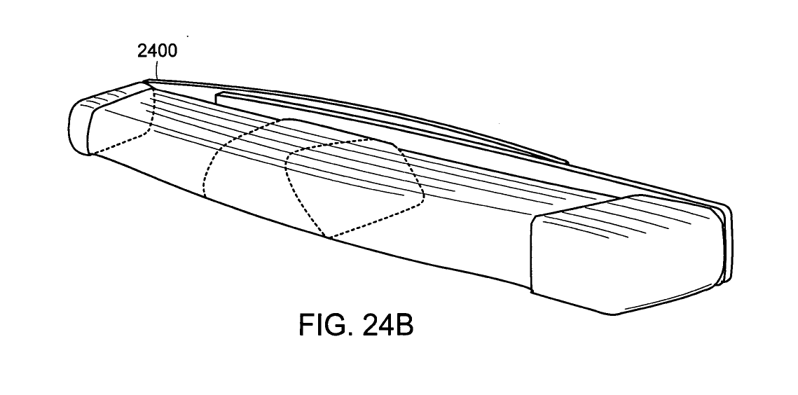

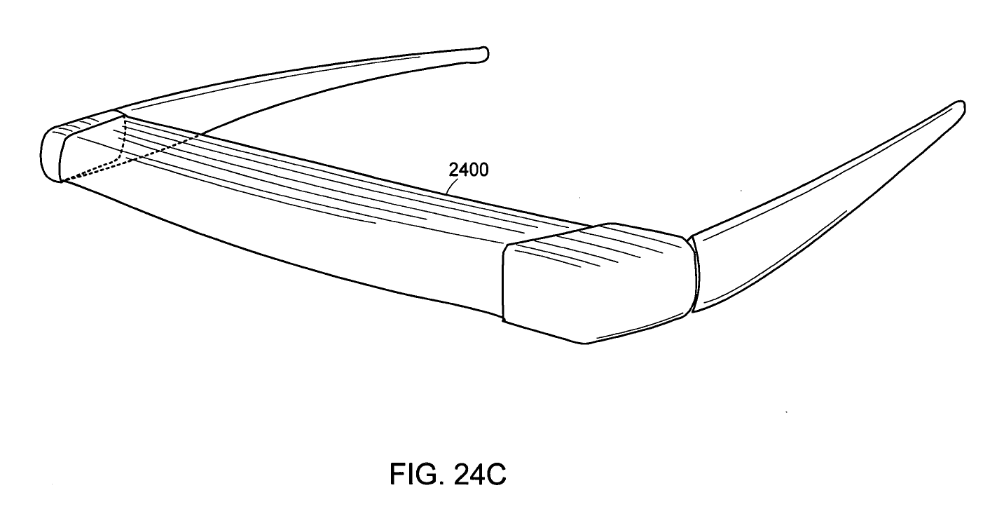

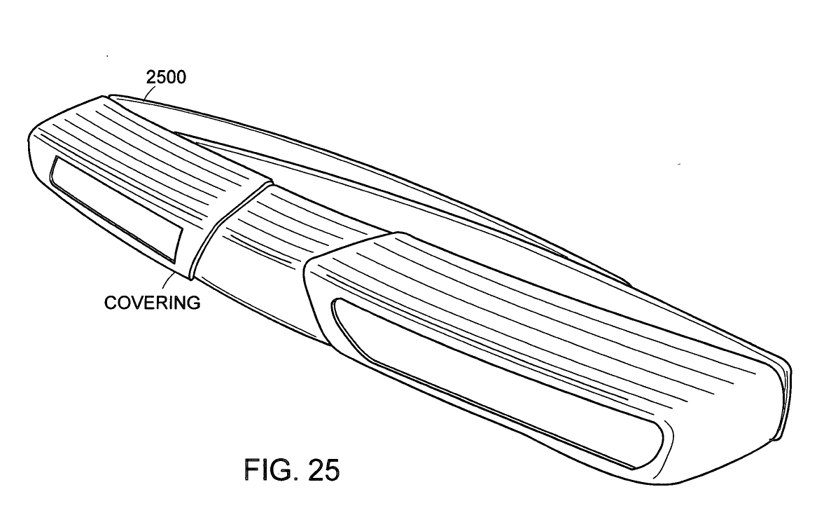

FIGS. 24A-24C are perspective views of a head-mountable display system 2400 according to yet another embodiment of the invention. The system 2400 includes a clear lens assembly 2404 and a display pod 2408 (only one shown) on both sides of an optional nose bridge 2402 (FIGS. 24A, 24B). Although not shown, speakers can be attached to the temple arms. The display system 2400 can be folded as shown in FIG. 24B for carrying or storage.

FIG. 25 is a perspective view of a display system 2500 similar to that of FIGS. 24A-24C. The covering can be placed over the lens assemblies.

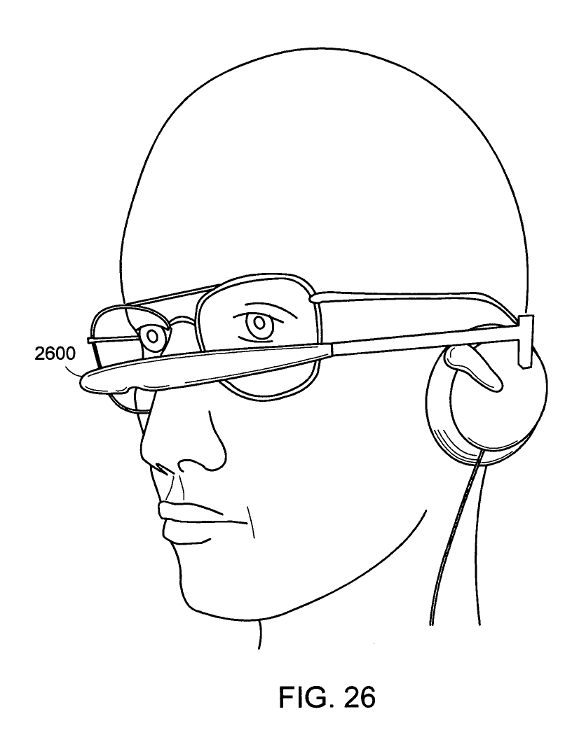

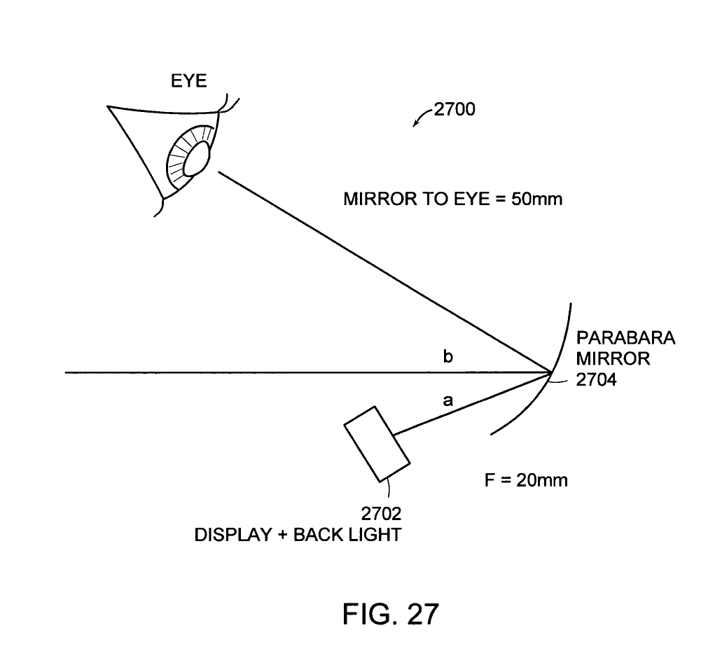

FIG. 26 is a perspective view of a display system 2600 according to yet another embodiment of the invention being worn by a user wearing glasses. The display assembly can be tilted relative to the temple arms to increase user comfort. An example of a particular mirror-lens technology 2700 is schematically shown in FIG. 27.

As shown, a parabolic or spherical mirror 2704 is configured to reflect and magnify an image for a display component, such as a backlit LCD display 2702. The focal distance (F) from the LCD to the mirror can be 20 mm, with the distance from the mirror to the eye being 50 mm. Measured from the optical axis of the mirror, the optical axis from the LCD is at an angle a, and the optical axis from the eye is at an angle b. In addition, a correction lens can be disposed closed to the LCD to correct image distortions, especially when the mirror is spherical. The system 2700 can be fabricated as an optics module that can be used in a head-mountable display system or other imaging devices, such as cameras, camcorders, telephones, etc. The optics can, in particular, incorporate a Holographic Optic Element (HOE), which can allow for larger reflection angles (angle of LCD display to mirror axis) to yield a more compact module or a specialized form factor.

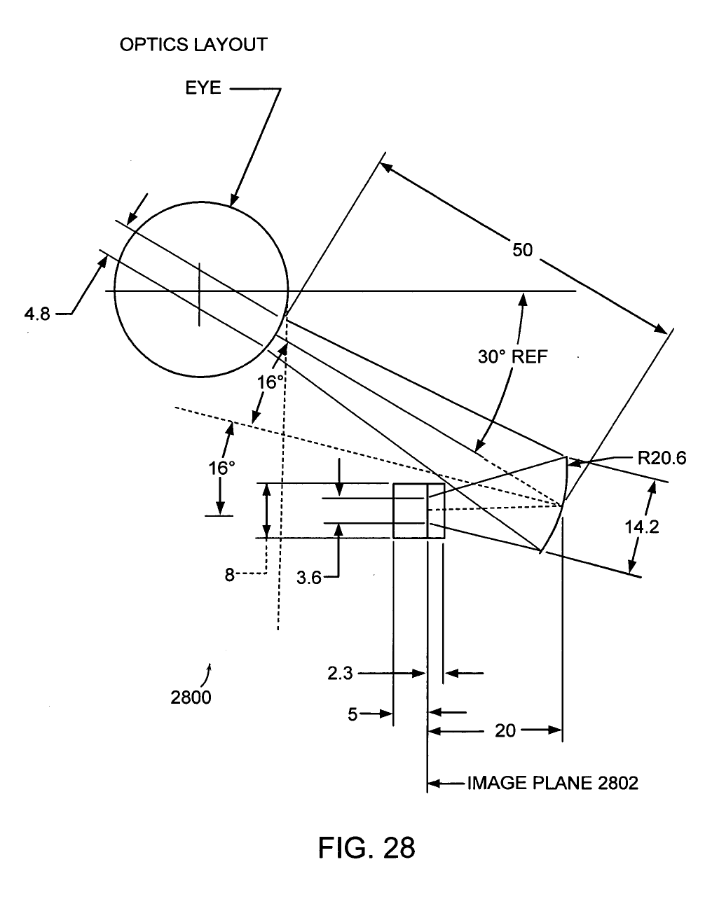

FIG. 28 is a detailed schematic diagram of a particular optical system of FIG. 27. The diagram assumes an eye pupil diameter of 4.8 mm. All measurements are in millimeters. Although not shown, the display component is rigidly coupled to the mirror to maintain the focal length. The dimensions can be varied to accommodate various optical arrangements. A description of various embodiments follows.

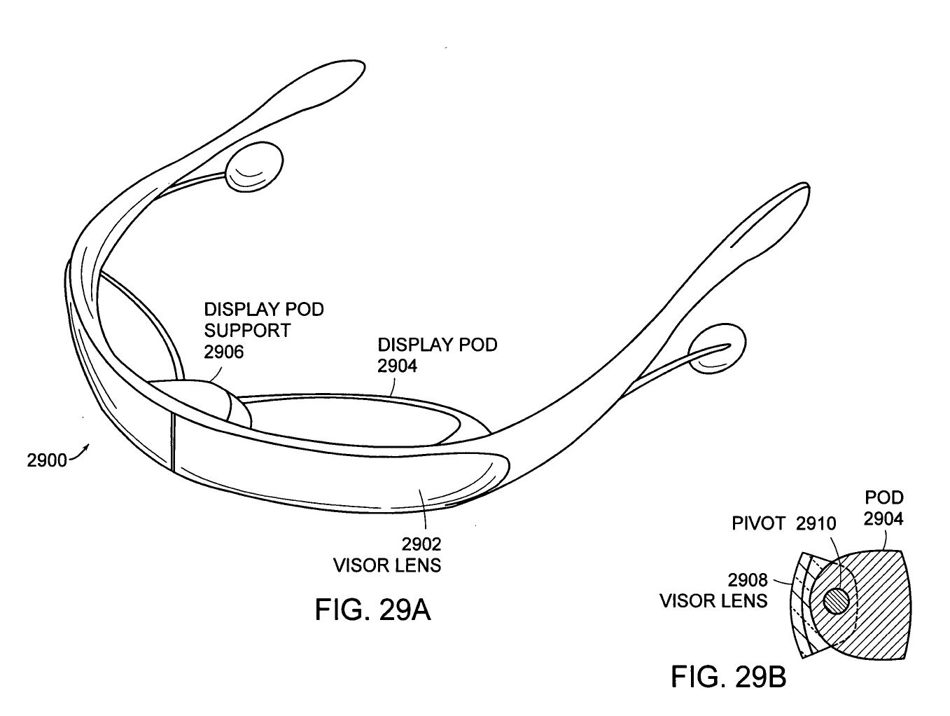

FIG. 29A is a perspective view of a head-mountable display system 2900 having a pivotable display pod 2904. As shown, the display system 2900 is a binocular system having two monocular display pods. The display pods 2904 are each coupled to a center display pod support 2906. The display pods 2904 can be based on concave reflective mirror optics, such as described in FIGS. 27 and 28.

FIG. 29B is a plan view of a display pod 2904 and display pod support 2906 of FIG. 29A. The display pod can pivot about the support, as shown.

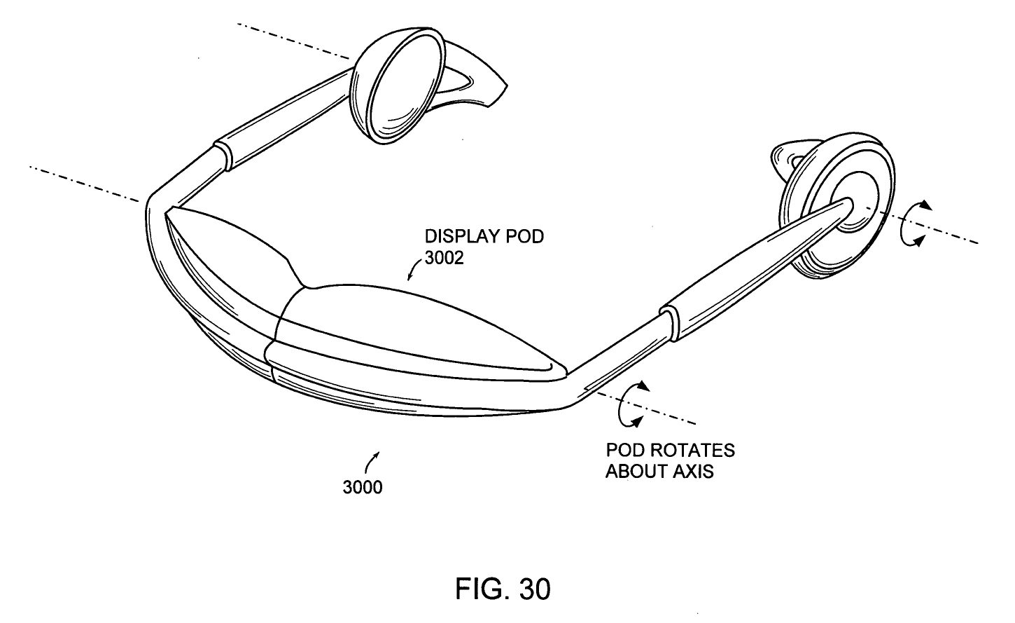

FIG. 30 is a perspective view of a head-mountable display system 3000 having a pivotable display pod 3000. The display pods can be based on concave reflective mirror optics, such as described in FIGS. 27 and 28. As shown, the two display pods can pivot about the headset frame.

FIG. 31 is a perspective view of a head-mountable display system 3100. The display pods can be based on concave reflective mirror optics, such as described in FIGS. 27 and 28. Again, any of the headsets described herein can be used.

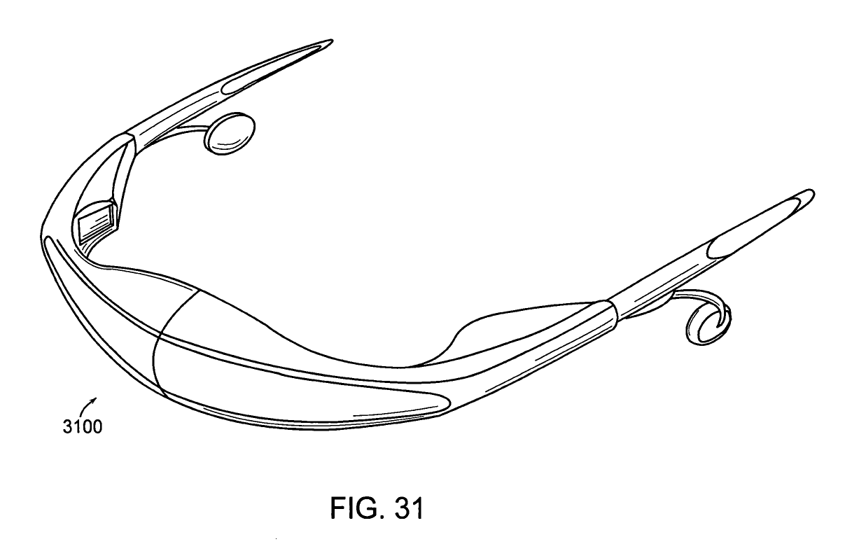

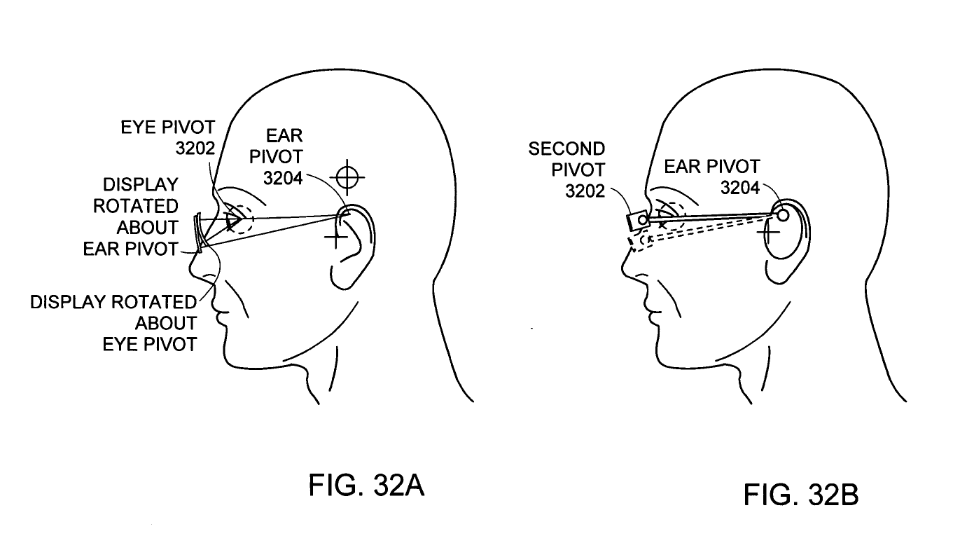

FIGS. 32A-32B are schematic diagrams showing particular rotational requirements for a display pod. As shown in FIG. 32A, a display pod rotated about the associated eye pivot 3202 can track the eye's optical axis. A display pod rotated about an ear pivot 3204, however, would not track the eye axis. As shown in FIG. 32B, a display system can be pivoted about both the ear and eye.

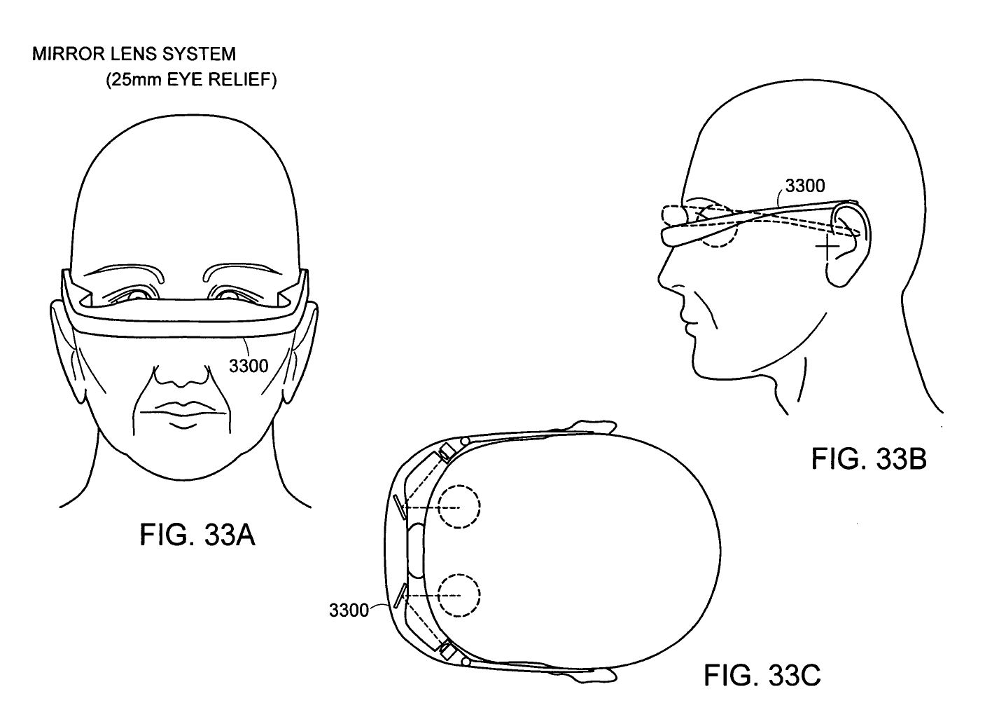

FIGS. 33A-33C are schematic diagrams of a particular embodiment of the display system of FIG. 31. The display system 3300 uses the above-described mirror-lens system and has an eye relief of 25 mm. The LCD is located at the side of the head and the mirror has minimal tilt from the eye axis.

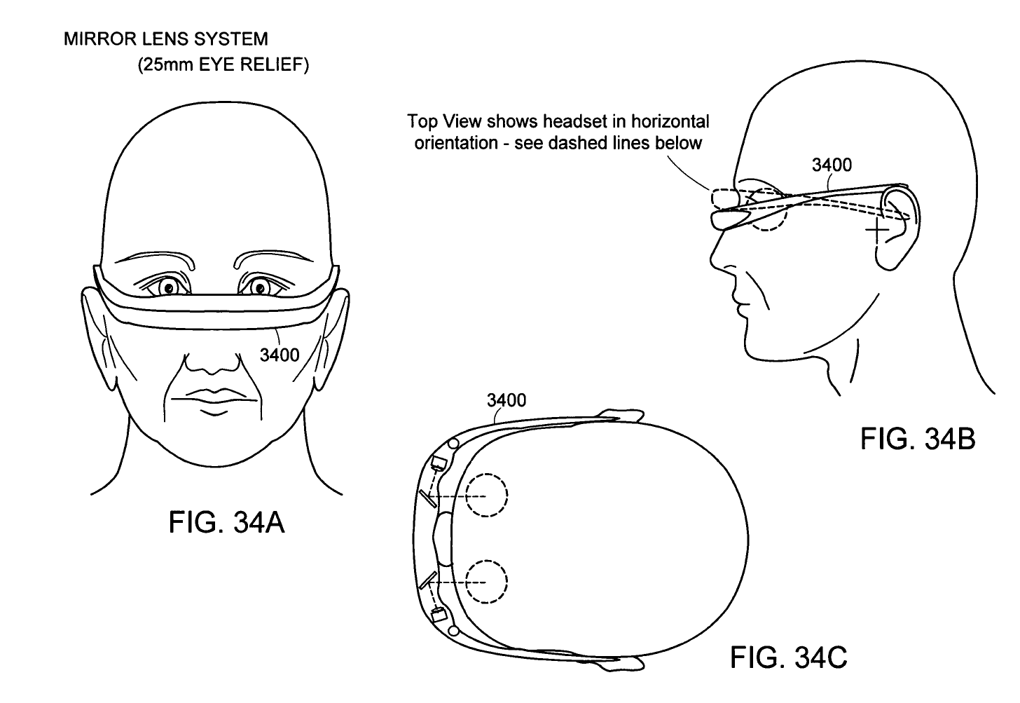

FIGS. 34A-34C are schematic diagrams of a particular embodiment of the display systems of FIGS. 29A-29B and 30. As shown, display system 3400 is based on the above-described mirror-lens system and has a 25 mm eye relief. The LCD is placed close to the mirror and the mirror is tiltable.

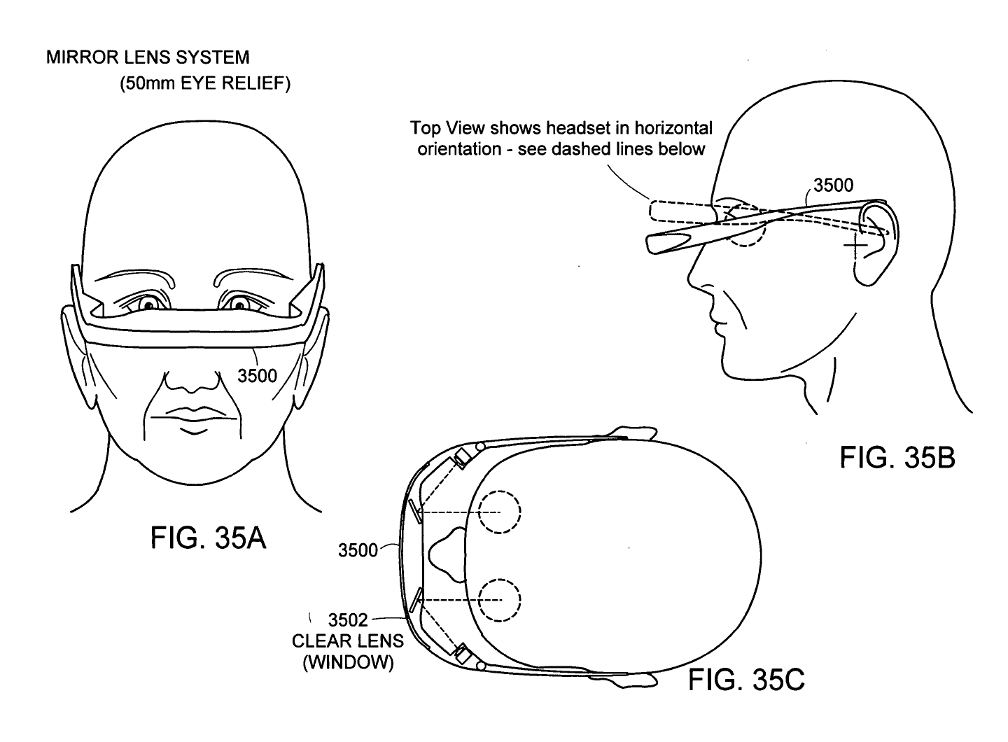

FIGS. 35A-35C is another particular embodiment of the display system of FIG. 31. The system 3500 also uses the above described mirror-lens system, but has a 50 mm eye relief.

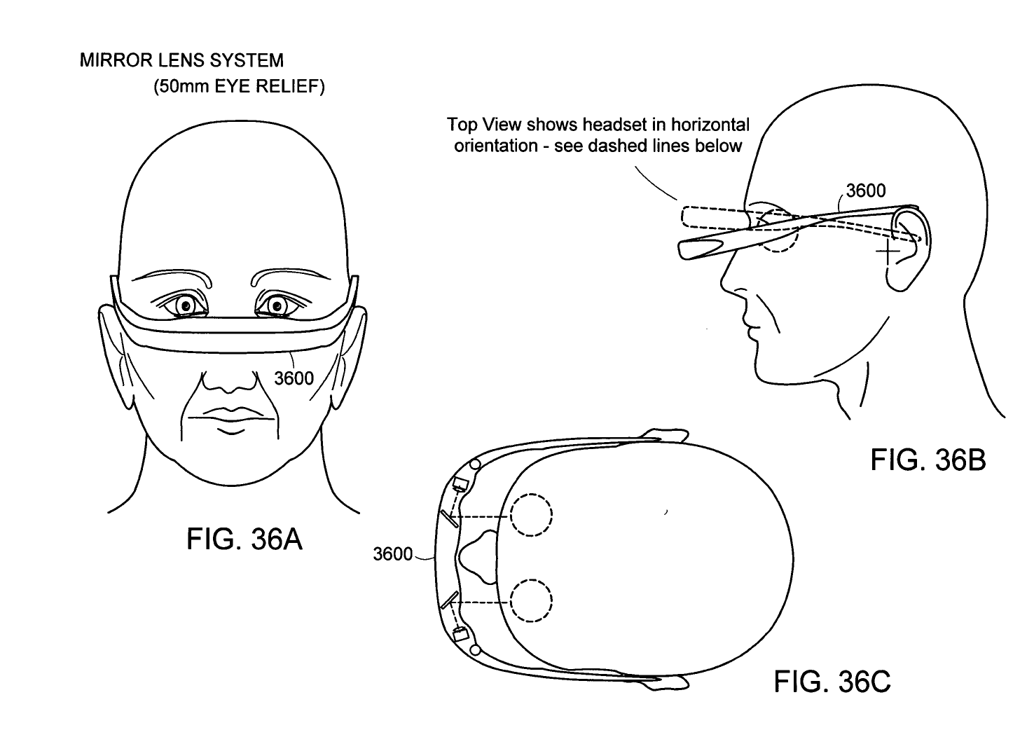

FIGS. 36A-36C is another particular embodiment of the display systems of FIGS. 29A-29B and 30. Again, this system 3600 uses the above described mirror-lens system, but has a 50 mm eye relief.

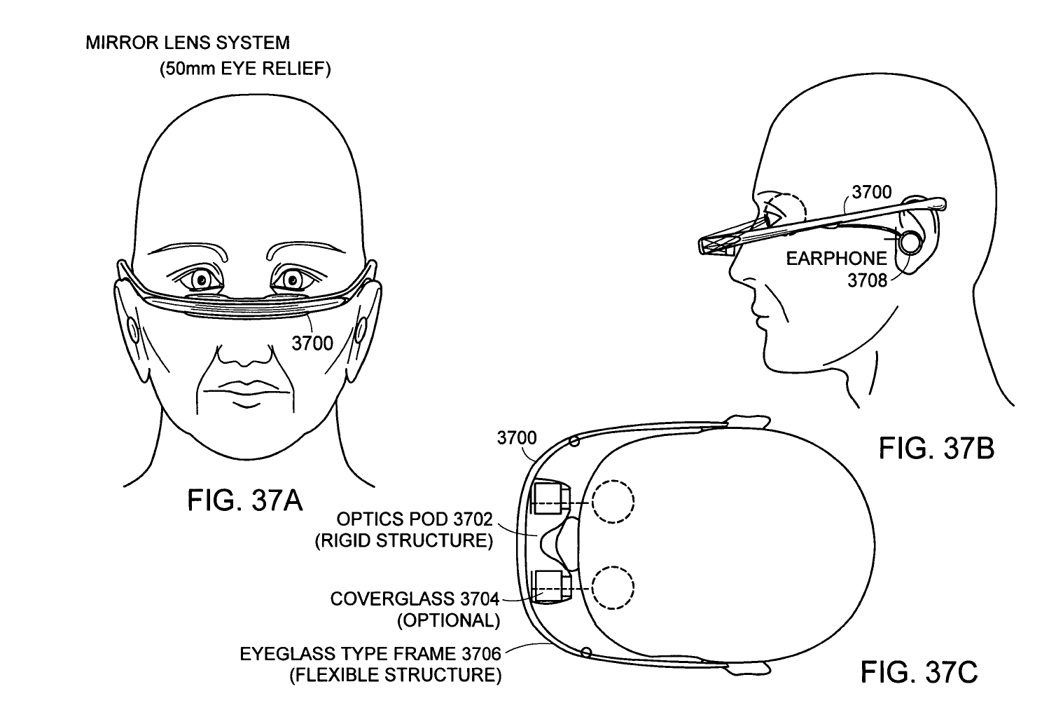

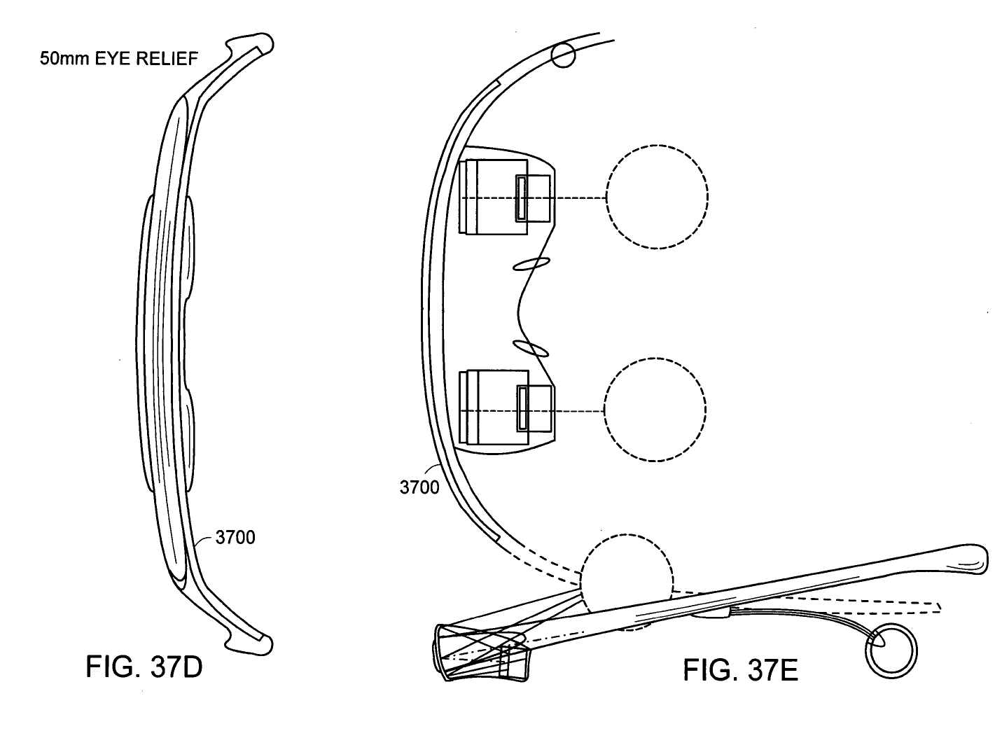

FIGS. 37A-37E are schematic diagrams of a display system 3700. The display system includes a rigid binocular optics pod 3702 mounted to a flexible structure 3706, such as an eyeglass-type frame. The mirror system is light weight and has a small side view. The eye relief is 50 mm. or more.

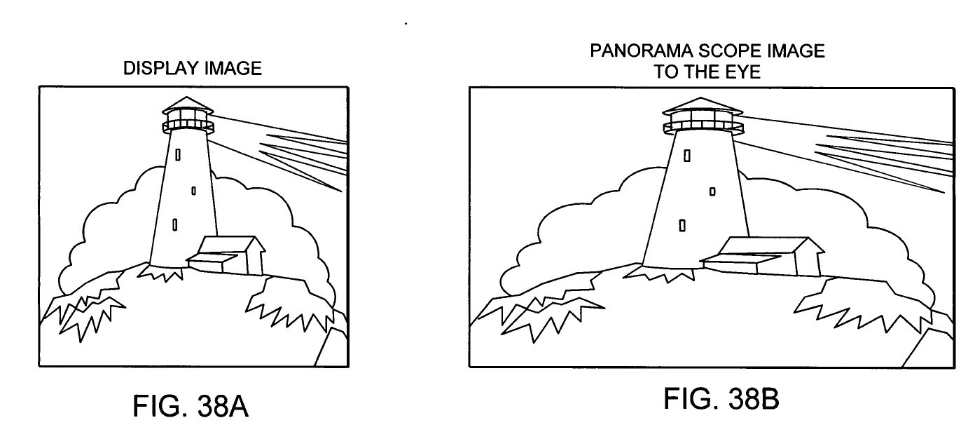

FIGS. 38A-38B illustrate a panorama scope image in accordance with a particular embodiment of the invention. As shown in FIG. 38A, the image formed on the LCD display is a square image (or a conventional TV image). As shown in FIG. 38B, the image seen by the user is an HDTV format image.

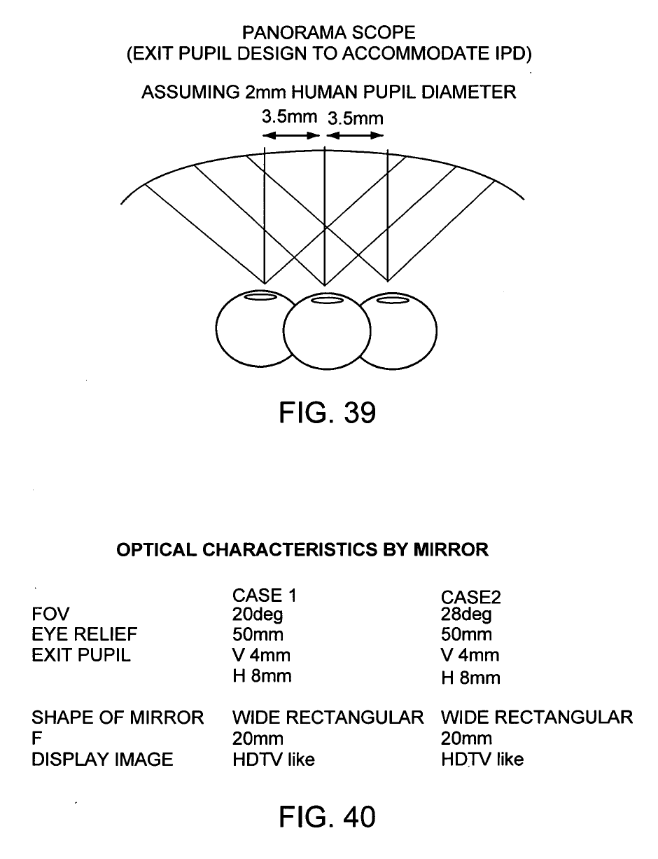

As shown in FIG. 39, the imaging of FIGS. 38A-38B can be realized to also solve IPD problems in addition to yielding a dynamic wide display image. Instead of a normal expansion of the image proportional to the display panel, a mirror and/or lens arrangement can be employed to reformat the image to yield the HDTV formatted image. This optical system can include multiple focusing points. The eye relief can be wide enough to accommodate a suitable IPD. As shown, the multiple focusing points allow for some distortions at both ends, without adding to human medical problems.

In particular, the mirror dimensions can be varied to accommodate various optical characteristics. An example of two sets of characteristics is shown in FIG. 40.

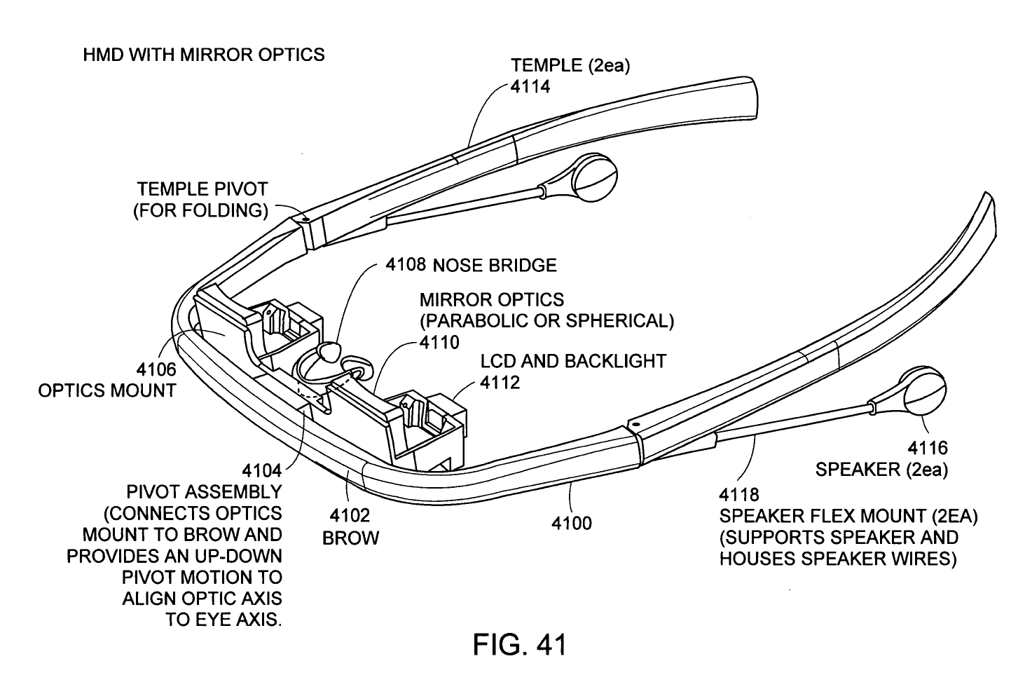

FIG. 41 is a perspective drawing of yet another head-mountable display device 4100. The device employs the above-described mirror optics, which can be parabolic or spherical.

A central brow member 4102 is coupled to left and right temple members 4100 by respective hinges. As shown, stereo speakers 4116 descend from the temples. The speakers are supported by a flexible mount 4118, which also acts as a conduit for speaker wires.

An optics mount 4106 for supporting the binocular display assembly is connected to the brow member 4102 by a pivot assembly 4104. A pair of display modules is each connected by a support member to the optics mount. Each display module includes an LCD and a backlight 4112. The mirror optics 4110 are also connected to the optics mount. The pivot assembly allows an up-down pivot motion to align the optic axis to the eye axis.

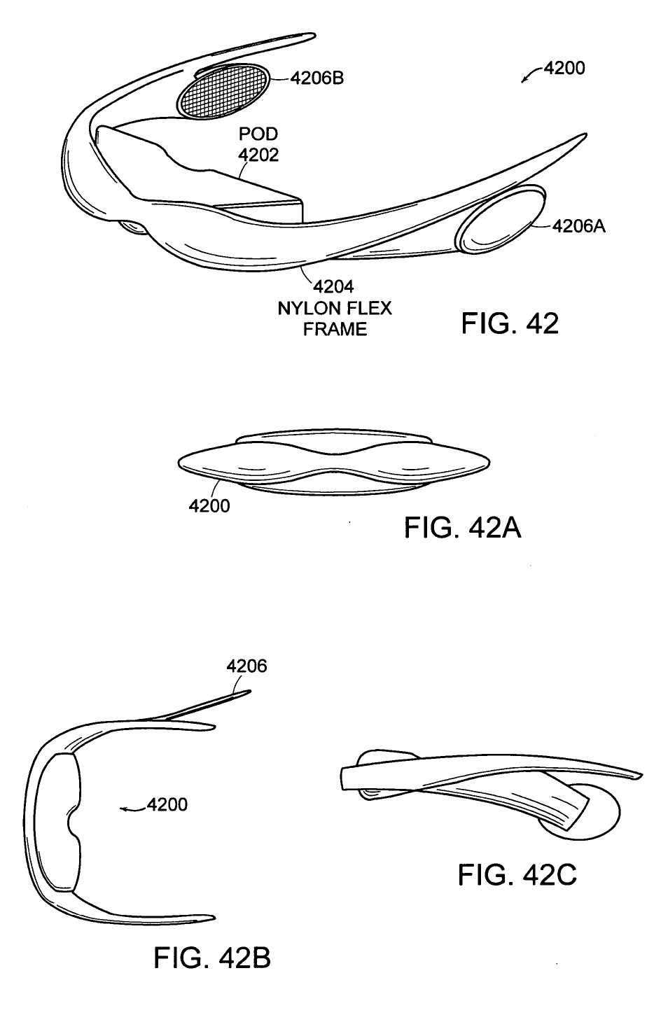

FIG. 42 is a series of drawings of yet another head-mountable display device 4200. The device 4200 can be made out of flexible frame. Such a flexible frame can be constructed out of nylon, or other appropriate materials. The flexible frame 4204 can be translucent, metallic, or of any other color, as determined by one skilled in the art. The frame 4204 can incorporate the temple arms, and speaker headphones 4206a, 4206b can be attached directly to the frame as shown. Display pod 4202 can house a display assembly.

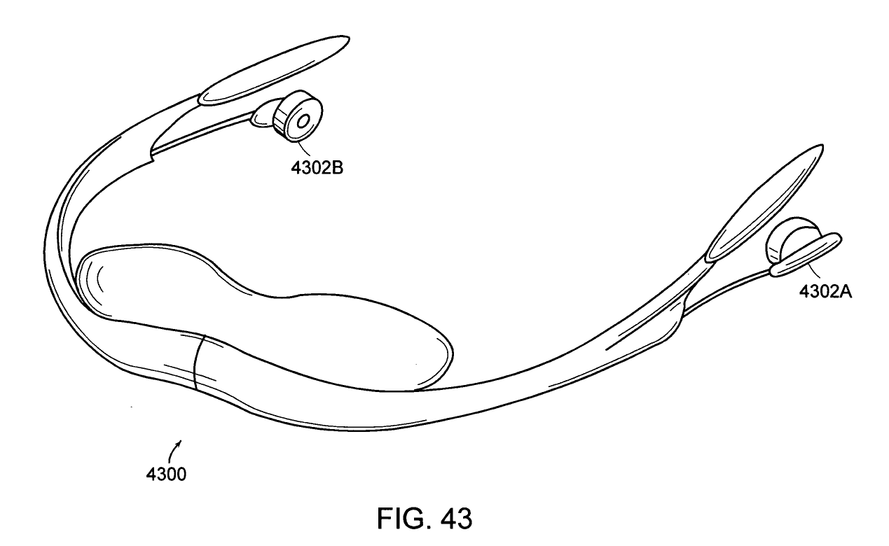

FIG. 43 is a perspective drawing of a head-mountable display device 4300 of yet another embodiment of the invention. The device 4300 can also be constructed out of flexible material, such as, for example, nylon. Speaker headphones 4302a, 4302b can be the in-the-ear speaker phones, and can be attached to the frame as shown.

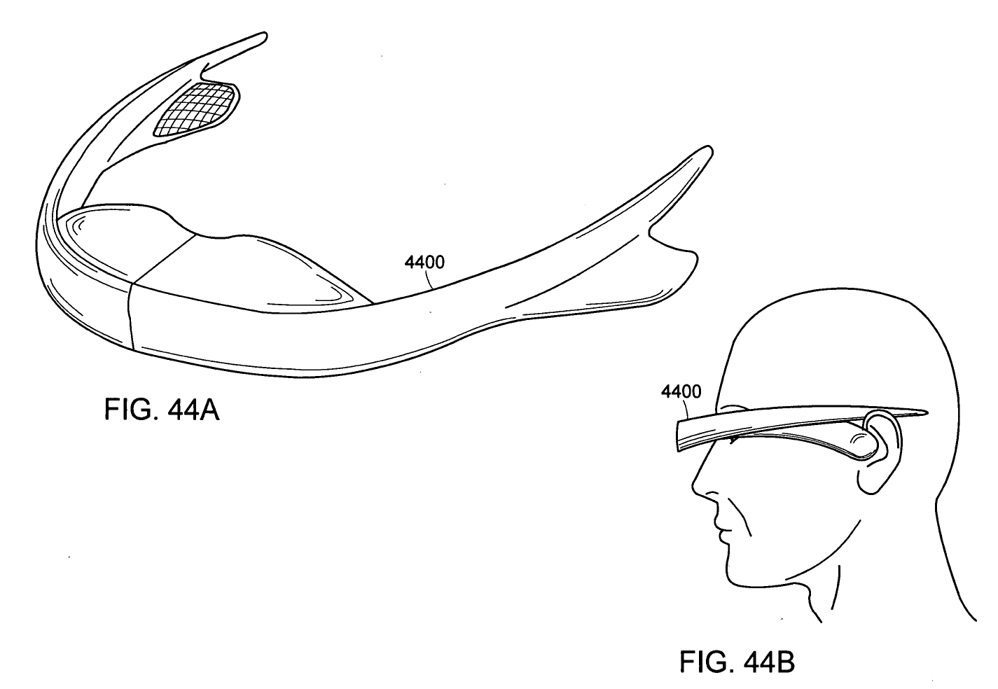

FIGS. 44a and 44b are perspective drawings of yet another head-mountable display device 4400. Display device 4400 can also be constructed out of light material.

Constructing head-mountable display devices, such as, for example, those shown in FIGS. 42-44, out of nylon can be particularly desirable because of the advantages of such a material. The nylon flexible frames can be durable, light, and easy to use and adjust. Furthermore, in a particular embodiment of the invention, such frame can be integrated with the display and earphone components, thus making it more comfortable for the user. Speaker cables and other electronic cables can be routed in the frame.

Various speaker systems can be used with the foregoing embodiments. For example, a semi-open speaker system can be used. The speaker system can either be close, but not contacting, the ear—a “semi-open ” system—or have pads that contact and seal the ear. Pads can provide a full seal for closed system or be porous, providing a partial seal for the semi-open system. These systems can be designed for stereo sound or, using multiple speakers, for 3D sound. The in-the-ear speakers can be used. They can be worn like earplugs, giving a full-seal closed system with stereo sound.

The head-mountable display system can utilize color filter displays. Electronics can be located in a box on the side of one of the temple arms. A flexible circuit can be used to connect the electronics to a flex circuit under the optics, further connecting the optics to the displays, backlights and audio speakers. The input interface box can connect to video and audio cable from a source like a game system, DVD player, etc.

The interface box can house various controls, such as, for example, volume and audio amplifier controls. The cable can connect the box to the head-mountable display system. A power supply system can also be connected to the interface box. The box can be located on the floor or table, but it can also be mounted on the user with a belt-mount.

While this invention has been particularly shown and described with references to particular embodiments, it will be understood by those skilled in the art that various changes in form and details can be made to the embodiments without departing from the scope of the invention. For example, a feature from one embodiment can be combined with a feature from another embodiment, including headset designs or any combination of such features.

What is claimed is:

1. A display system comprising:
a frame wearable on the head of a user; and
an imaging system coupled to the frame, the imaging system presenting a viewable image to the user at a view angle relative to the user's eye level.

2. The display system of claim 1 wherein the imaging system is rotatable to adjust the view angle.

3. The display system of claim 2 wherein the imaging system includes a display pod.

4. The display system of claim 1 wherein the imaging system includes a mirror-lens optical system.

5. The display system of claim 1 wherein the imaging system includes an optical relay.

6. The display system of claim 1 wherein the frame is essentially transparent within the user's field of view.

7. The display system of claim 1 wherein the frame is shaped to facilitate peripheral vision of the user.

8. The display system of claim 1 wherein the imaging system includes a free-form prism.

9. The display system of claim 8 wherein the prism is vertically aligned relative to the user.

10. The display system of claim 8 wherein the prism is horizontally aligned relative to the user.

11. The display system of claim 1 wherein the imaging system is mechanically isolated from the frame.

12. The display system of claim 1 wherein the viewing angle is from below the user's eye level.

13. The display system of claim 1 wherein the imaging system includes an aspheric lens folded optical system..

14. The display system of claim 13 wherein the optical system has a field of view of at least about 20°.

15. A method for use of a display system by a user, the method comprising:
wearing a frame on the head; and
viewing, at a view angle relative to the eye level, a presented viewable image on an imaging system coupled to the frame.

16. The method of claim 15 further comprising rotating the frame to adjust the view angle.

17. The method of claim 15 wherein the imaging system includes a display pod.

18. The method of claim 15 wherein the imaging system includes a mirror-lens optical system.

19. The method of claim 15 wherein the imaging system includes an optical relay.

20. The method of claim 15 wherein the frame is essentially transparent within the user's field of view.

21. The method of claim 15 wherein the frame is shaped to facilitate peripheral vision of the user.

22. The method of claim 15 wherein the imaging system includes a free-form prism.

23. The display system of claim 22 wherein the prism is vertically aligned relative to the user.

24. The method of claim 22 wherein the prism is horizontally aligned relative to the user.

25. The display system of claim 15 wherein the imaging system is mechanically isolated from the frame.

26. The display system of claim 15 wherein the viewing angle is from below the user's eye level.

27. The display system of claim 15 wherein the imaging system includes an aspheric lens folded optical system..

28. The display system of claim 15 wherein the optical system has a field of view of at least about 20°.

29. A method of making a display system, comprising:
fabricating a frame wearable on the head of a user;
fabricating an imaging system for presenting an image; and
coupling the imaging system to the frame so that the presented image is viewable at a view angle relative to the user's eye level when worn.

30. The method of claim 29 wherein the imaging system is rotatable to adjust the view angle.

31. The display system of claim 29 wherein the imaging system includes a display pod.

32. The display system of claim 29 wherein the imaging system includes a mirror-lens optical system.

33. The display system of claim 29 wherein the frame is essentially transparent within the user's field of view.

34. The display system of claim 29 wherein the frame is shaped to facilitate peripheral vision of the user.

35. The display system of claim 29 wherein the imaging system includes a free-form prism.
